(19) United States
(12) Patent Application Publication
(10) Pub. No.: US 2013/0163885 A1
(43) Pub. Date: Jun. 27, 2013

(54) INTERPOLATING SUB-PIXEL INFORMATION TO MITIGATE STAIRCASING

(71) Applicant: Maksim Lepikhin, Boulder, CO (US)

(72) Inventor: Maksim Lepikhin, Boulder, CO (US)

(73) Assignee: MICROSOFT CORPORATION, Redmond, WA (US)

(21) Appl. No.: 13/333,916

(22) Filed: Dec. 21, 2011

(51) Int. Cl. G06K 9/32; G06K 9/64; G06K 9/56

(52) U.S. Cl. 382/205; 382/300; 382/278

(57) ABSTRACT

A surface model may be created from aerial photographs, while mitigating the staircase effect, by interpolating sub-pixel values in the photographs and using those sub-pixel values to calculate the offset between overlapping photographs. Aerial photographs are taken, which include overlapping regions. For a pair of photographs, the photographs are rectified to create coordinate systems in which the photographs have x-axes that coincide and y-axes that are parallel to each other, so that overlapping regions in one photograph are a fixed offset along the x-axis from the other photograph. Analytic functions are used to interpolate values between pixels, and the offset distance is calculated by finding the offset that maximizes a similarity function over the analytically interpolated values. The calculated offset may then be used to calculate the height of a point on the photographed surface. A surface model may be built by calculating the heights of many points.

### BACKGROUND

A digital surface model (DSM) provides a model of a terrain. A model of a terrain is, in effect, a function that identifies the height of the land (or of an object on the land, if such objects are to be included in the terrain model), at any given point on the terrain's surface. For example, a function that identifies the height of a mountain for any given latitude and longitude coordinate within the mountain range is effectively a DSM for that mountain range.

A DSM is typically constructed from overlapping aerial photographs. Aerial photographs are taken, and points on one photograph are mapped to points on another photograph. By knowing the altitude of the camera, the angle between the camera and the horizon for each of the two photographs, and the distance between the camera positions at which the two photographs were taken, it possible to calculate the height of the point using the trigonometric process of triangulation. By performing this process for many points, a model of the terrain can be constructed.

A problem that arises when constructing a model by this method is that the camera has a finite resolution, which effectively quantizes the distances that can be calculated from the photographs. Aerial photographs typically have about a 30-centimeter horizontal resolution (i.e., each pixel represents a width of about 30 centimeters), but this translates to about a four-meter vertical resolution when triangulation is used to calculate vertical heights from the photographs. (The mathematics of triangulation tend to magnify imprecision of the horizontal resolution.) Thus, the modeling technique generally models a smooth terrain as if it were a series of four-meter jumps. When the model is used to show an image of the terrain, these jumps often make a rolling or mountainous terrain look like a staircase, so the effect of this low resolution is often called the “staircasing effect.”

### SUMMARY

The staircasing effect in a terrain model may be reduced or mitigated by interpolating values at the sub-pixel level, and using the interpolated values to more accurately calculate horizontal distances. Using the interpolated values to calculate horizontal distances yields more finer-grained (albeit synthetic) horizontal distance data. The finer-grained horizontal distances may be used as input to a triangulation algorithm, which results in being able to calculate heights at a higher resolution, which leads to a smoother terrain model with minimal or no visible staircasing.

In order to build a terrain model, aerial photographs are taken, which overlap to some degree, thereby providing some points that appear in at least two different photographs. The photographs may be rectified to align their axes, such that the two photographs represent surfaces in aligned planes, and with commonly-calibrated rectangular coordinate systems. Thus, the x-axes of the two photographs coincide and the y-axes of the two photographs are parallel to each other at a horizontal distance of d. The result is two photographs such that—within the overlapping region—any point (x,y) in one photograph corresponds to a point (x+d,y) in the other photograph, although the exact value of distance d is unknown at this point.

In order to find the approximate distance d, pixels in the two photographs are compared for similarity under different possible values of d. That is, for values dₙ, pixels (x,y) in one photograph and (x+dₙ,y) in the other photograph are compared. The value of dₙ, that results in the highest overall level of similarity between the corresponding pixels is considered to be the approximate distance between the photographs. (Another way of viewing this is to define the cost as being 1 minus the overall level of similarity; the value of dₙ that minimizes the cost may be taken to be the approximate distance.) The chosen value of dₙ is referred to herein as d*. It is noted that calculation of similarity (or “cost”, which is effectively an inverse of similarity) may be followed by global optimization (smoothing) that assumes that resulting surface is generally continuous. Then, d may be calculated from the smoothed cost, rather than from a cost based only on local image properties.

Sub-pixel values may then be modeled as analytic functions interpolated between the actual pixels. One way to perform this interpolation is to define linear functions between each pair of adjacent pixels, and to use the values of those linear functions as the sub-pixel values. Using the interpolated sub-pixel values, the initial approximate distance, d*, that was found to exist between the two photographs may be refined. That is, sub-pixel-level adjustments in d* can be made by comparing interpolated values in one photograph with interpolated values in the other photograph, and trying to find an offset, t, from d*, such that the distance d=d*+t minimizes the cost, when the cost is calculated on those interpolated values.

Once a value of d is found in this way, the value may be used to triangulate the height of points that appear in multiple photographs. By calculating the heights for many points, a model of the terrain may be created.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process of creating a digital surface model of a terrain.

FIG. 2 is a diagram of an example rectification process.

FIG. 3 is a diagram showing an example of analytic function interpolation between discrete pixels.

FIG. 4 is a block diagram of example components that may be used in connection with implementations of the subject matter described herein.

### DETAILED DESCRIPTION

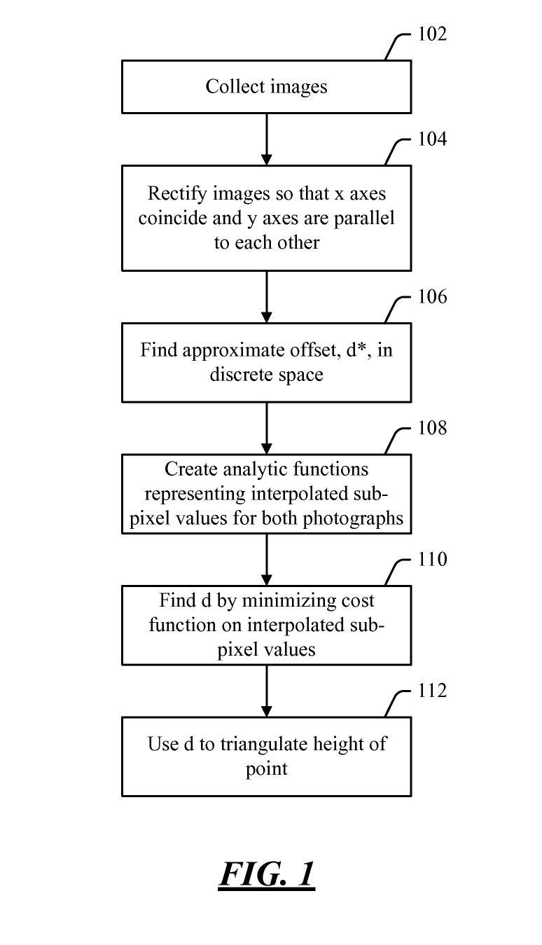

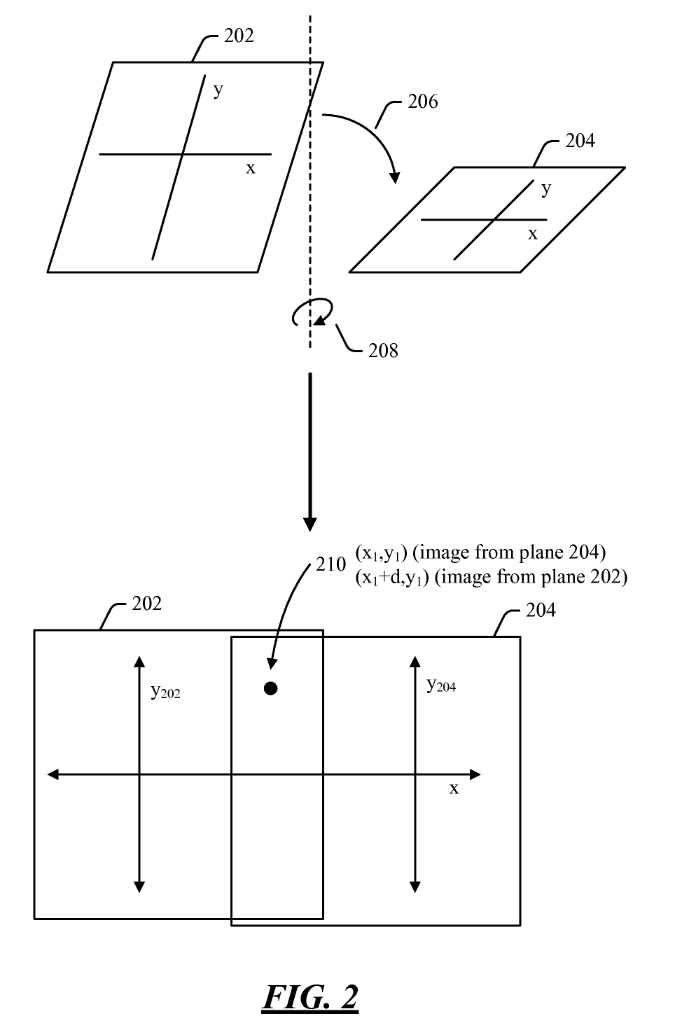

Turning now to the drawings. FIG. 1 shows an example process of creating a digital surface model (DSM) of a terrain. The process of FIG. 1 incorporates the staircasing mitigation technique described herein. The actions in the process of FIG. 1 will be described with reference to the diagrams in FIGS. 2-4.

At 102, images are collected. The images that are collected may be aerial images that are obtained by attaching a camera to an airplane, and capturing images from various locations while flying over a geographic area. Techniques and equipment for capturing aerial images are generally known. The images that are captured may be overlapping—i.e., there may be a portion of image A that also appears in image B. This is not to say that images A and B are the same as each other, but rather that they may contain a common portion. The common portion between two images provides reference points that can be used to align the coordinate systems of the two images, and also provides points that can be used to calculate heights, which can be triangulated using the angles at which two photographs of the same point were taken. (The fact that the coordinate systems can be aligned is used later in the process.)

While the images are being captured, certain data relating to the images may be recorded. For example, the altitude of the airplane at the time an image was taken may be recorded. (In one example, the plane flies at a constant, or near-constant, altitude.) Additionally, the angle of the camera lens (e.g., the angle between the lens's central line and the horizon) may be recorded. Other information that may be recorded may include the type of lens, the focal length, the aperture, the shutter speed, the angle of view, or any other data that may aid in analysis of the photographs captured with the camera. The result of the image collection process that occurs at 102 is a plurality of aerial images of a geographic area.

At 104, pairs of images captured by the camera are rectified in order to align their coordinate systems. The pictured captured by the camera may be taken at various different angles, and from various different positions in the air. These differences results in the subject planes of the image being skewed differently, and in the images having different centers. The goal of the rectification process is to align the coordinate systems of two images, so that each image's coordinate system becomes just a horizontal translation of the other images' coordinate systems along the x axis. In other words, after rectification is performed, the x-axes of the images will coincide, and the y-axes of the images will be parallel to each other. (The same process could also be performed by making the y-axes coincide and the x-axes parallel to each other; or, a different type of coordinate system may be used. While the subject matter herein is not limited to any particular coordinate system, for the purpose of simplifying the explanation, the description herein will use the running example in which rectification causes the x-axes to coincide and the y-axes to be parallel to each other.) FIG. 2 demonstrates an example of the rectification process.

FIG. 2 shows two planes 202 and 204, which represent the subject planes of two different images. It will be observed that planes are skew to each other, which may result from the images having been captured at different camera angles. One of the planes (e.g., plane 202) may be tilted (arrow 206), so that the coordinate axes of planes 202 and 204 are coplanar. Additionally, plane 202 may be rotated (arrow 208), so that the x-axes of planes 202 and 204 can be made to coincide, and the y-axes (marked y₂₀₂ and y₂₀₄ in the lower part of FIG. 2) can be made parallel to each other. The result is the versions of planes 202 and 204 that are shown toward the bottom of FIG. 2. In that version, planes 202 and 204 are simply linear translations of each other along the x-axis, so that a point 210 that appears in the images represented by both planes can be described by the coordinates (x₁,y₁) in plane 204, and (x₁+d,y₁) in plane 202, for some offset value d.

Returning now to FIG. 1, the value of d at this point in the process is not actually known. I.e., two images at this point have been aligned so that at least some region of one image also appears in the other image shifted along the x-axis, but it is not known how far one has to shift along the x-axis to align the common points in the two images. An approximate value of the offset between the images is determined in discrete space at 106, where this approximate offset is referred to herein as d*. Determining the offset in discrete space means finding the offset between pixels in the two photographs that yields the highest similarity between corresponding pixels, under the constraint that that offsets can only be in whole, not fractional, pixel widths. There are various ways to determining similarity between regions in a photograph. One technique is to use Normalized Cross Correlation (NCC), which is a measure of the similarity between two regions of an image (or, more generally, a measure of the similarity of two waveforms). Although NCC is one measure of similarity, other techniques to measure similarity may be used. When NCC is used, the NCC is calculated for each pixel in one image, and each corresponding pixel the other image, for different possible offsets. That is, for a set of possible discrete offsets dᵢ, the NCC between (x,y) in one image and (x+dᵢ,y) in the other image is calculated. d* is then set equal to whichever value of dᵢ yields the highest overall level of similarity between pixels from the two images.

It is noted that maximization of similarity is often described in terms of minimization of a cost function. That is, if S(d*) represents the similarity of two photographs at an offset of d*, then C(d*)=1−S(d*) represents the “cost” of choosing d* as the offset, where the cost is effectively the “badness” of that choice. Minimizing the cost, or maximizing the similarity, are different way of describing what is effectively the same technique.

Since pixels are atomic units of an image, the appearance of the subject represented in a digital image is known only to the precision of the size of the image's pixels. The underlying subject of a photograph may have an arbitrary level of detail, but a single pixel value is chosen to represent all of the visual information in whatever size area the pixel represents. That single value may be an RGB, HSL, or HSV color vector, or may be a numerical gray-scale value in the case of a black-and-white color space. However, regardless of how much detail is in the area represented by a pixel, only a single value or vector is chosen to represent that entire area. As noted above, a pixel in an aerial photograph might represent 30 centimeters along the surface of the ground. Thus, for every 30 cm×30 cm square on the ground, only a single pixel value is chosen to represent all of the visual information in that square. This quantization of the image leads to a loss of detail. When only this level of detail is available, it is not possible to ask how the subject depicted in an image changes every 5 centimeters or 10 centimeters, since this level of detail is lost. It is for this reason that comparing pixels in discrete space yields only whole pixel offsets; there is simply not enough information in the photographs to determine whether adding a fractional pixel width to the offset would yield a more accurate offset. However, as noted above, when one is trying to calculate the heights of different points in a terrain, differences of 30 centimeters along the ground can produce differences as large as four meters when triangulation is used to calculate heights. Therefore, more accurate results could be produced if sub-pixel values were known.

One solution is to interpolate the sub-pixel values, and to re-calculate the cost of the offset using the interpolated values. This solution can be implemented at 108 and 110 of FIG. 1.

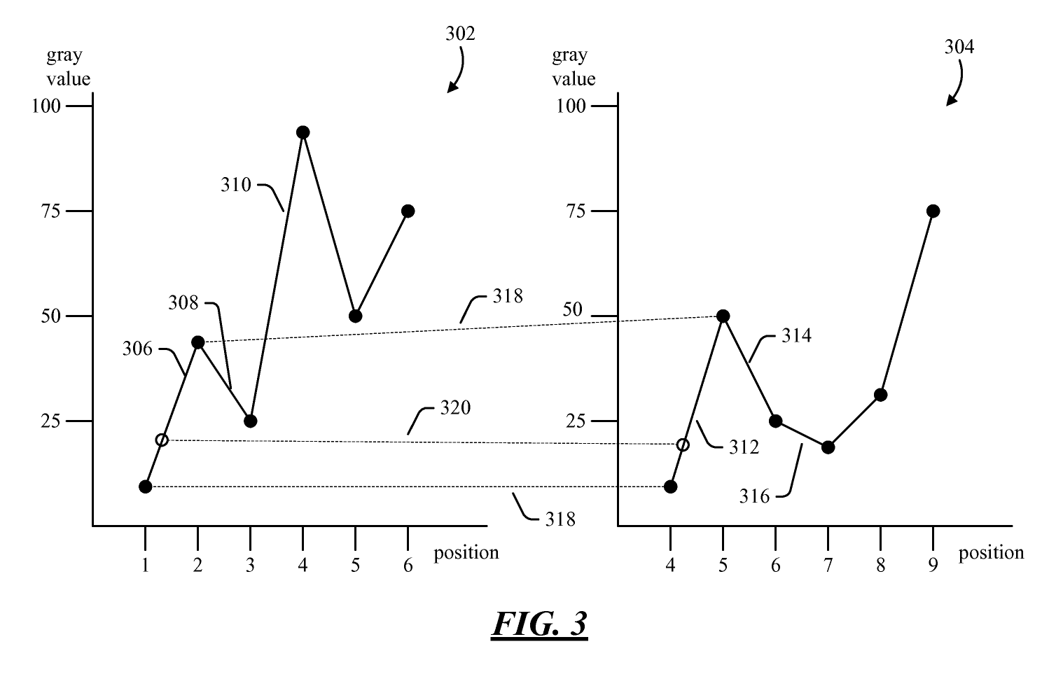

At 108, a set of analytic functions are created that interpolate sub-pixel values. An analytic function has a value over a real-valued interval. Thus, when an analytic function stands in for the actual pixel values, it is possible to calculate gray or color values for locations in a photograph that are fractional distances between two pixels. In one example, the analytic functions are linear, although any type of analytic function could be used (e.g., quadratic, cubic, exponential, sinusoidal, etc.). FIG. 3 shows a simplified example of how interpolation with analytic functions works, using the example in which the analytic function is a linear function. To simplify the illustration, FIG. 3 shows an example in which the pixel's spatial position is represented by a single-valued position coordinate, and the value of the pixel is a gray-scale value in the range 0-100. However, it will be understood that the location of a pixels on a planar surface would generally be described by an ordered pair rather than a single value, and the pixel value could be any type of value appropriate to the color space.

Graph 302 represents the pixel values in one photograph, and graph 304 represents the pixel values in another photograph. The solid dots in each photograph represent actual pixels and their values. For example, in graph 302, the pixel at coordinate 1 has a gray value of 10, the pixel at coordinate 2 has a gray value of 40, and so on. In graph 304, the pixel at coordinate 4 has value of 10, the pixel at coordinate 2 has a value of 50, and so on. If one is trying to evaluate the difference between the photographs represented by these graphs for an offset of 3, one can compare pixel values in one graph with the corresponding pixel values in the other graph, as indicated by lines 318 connecting these points. Only the solid, circular points shown in each graph represent actual data. However, analytic functions such as 306, 308, 310, 312, 314, and 316 may be used to interpolate values at the sub-pixel level—i.e., between the discrete coordinates. For example, using the analytic functions to interpolate sub-pixel values, it is possible to compare two sub-pixel points in a photograph, such as the circled points connected by line 320. In the example shown, the analytic functions happen to be the linear functions that pass through adjacent points, although non-linear functions could be used.

Additionally, while FIG. 3 shows linear interpolation between points in two dimensions, it will be understood that the functions involved would typically exist in three dimensions. Thus, if x and y are the horizontal and vertical coordinates of a pixel, and if g is the gray value of a pixel at point (x,y), the linear functions that interpolate sub-pixel values would typically have the form g=Ax+By+C (where A, B, and C are constants), which is the equation of a two-dimensional plane in three-dimensional space. In other words, if one were to show a graphical representation of a function in which linear functions are used to interpolate between known pixel values, the graph would typically look like a surface over the xy plane, where the surface would be made of distinct planar facets.

Returning now to FIG. 1, at 110 the value of d (the offset between the two photographs) is calculated using the interpolated values. In other words, with analytic functions standing in for actual pixel values, it is now possible to calculate the similarity between sub-pixels based on the interpolated sub-pixel data. Using these sub-pixel similarity comparisons, it is possible to calculate the cost function for offsets that have a precision less than a whole pixel. Since the error in the height calculation derives from errors in offset measurement, increasing the precision with which the offset can be calculated reduces the precision in the height calculations that are used to create the surface model.

Calculating d at the sub-pixel level of precision can be performed as follows. First, the process may look in the neighborhood of values around d*, since d* is known to be the discrete-valued offset that minimizes the cost in discrete space. The goal of using sub-pixel level interpolated values is to refine the discrete value that was found at 106. Thus, for a neighborhood around d*, the process attempts to find the value, t, such that d*+t provides the minimum NCC. In other words, define NCC(x,y,d*+t) as the similarity between two images assuming an offset of d*+t. Then, if NCC is calculated over a 3×3 window,

$$NCC ( x , y , {d}_{*} + t ) = \frac{\begin{matrix}{\sum }_{k = 1}^{9} \begin{matrix}( a ( x + {sx}_{k} , y + {sy}_{k} ) - \\ \overline{a ( x + {sx}_{k} , y + {sy}_{k} )} )\end{matrix} * \\ \begin{matrix}( b ( x + {sx}_{k} + {d}_{*} + t , y + {sy}_{k} ) - \\ \overline{b ( x + {sx}_{k} + {d}_{*} + t , y + {sy}_{k} )} )\end{matrix}\end{matrix}}{\begin{matrix}\sqrt{{\sum }_{k = 1}^{9} \begin{matrix}( a ( x + {sx}_{k} , y + {sy}_{k} ) - \\ {\overline{a ( x + {sx}_{k} , y + {sy}_{k} )} )}^{2}\end{matrix}} * \\ \sqrt{{\sum }_{k = 1}^{9} \begin{matrix}( b ( x + {sx}_{k} + {d}_{*} + t , y + {sy}_{k} ) - \\ {\overline{b ( x + {sx}_{k} + {d}_{*} + t , y + {sy}_{k} )} )}^{2}\end{matrix}}\end{matrix}}$$

where
   sxₖ={−1,0,1,−1,0,1,−1,0,1},syₖ={−1,−1,−1,0,0,0,1,1,1},
   a(x, y) is gray pixel value in first image
   b(x+t,y) is gray pixel value in second image, t ∈[−1,1]
      ā and b̅ are mean gray values in 3×3 window.
      If b(x+t, y) is a linear function of t, then NCC has the following form:

$$NCC ( t ) = \frac{D * t + E}{\sqrt{A * {t}^{2} + B * t + C}} ,$$

where A, B, C, D, and E are constants that depend on image values at x, y and its neighbors. In this case, the derivative of NCC(t) is a rational function whose numerator is a linear function, so the maximum of NCC(t) (and, equivalently, the minimum of the cost function) can be found analytically by finding the root of the linear function in the numerator of the derivative. However, it is noted that when non-linear interpolation functions are used, the minimum can still be found—either analytically, or by approximation if the root of the derivative cannot easily be calculated.

With this formula, d is found such that d=d*+t. It is noted that, theoretically one could omit the act of finding d*, and could simply minimize the cost function directly from the analytic interpolation functions. However, first finding d* gives an approximate value of d, which helps the algorithm to find d with fewer calculations that would be performed if the cost function had to be minimized over continuous-valued functions without any knowledge about where the minimum is likely to be.

The value of d may then be used to interpolate the height of the terrain at various points, using a process such as triangulation (at 112).

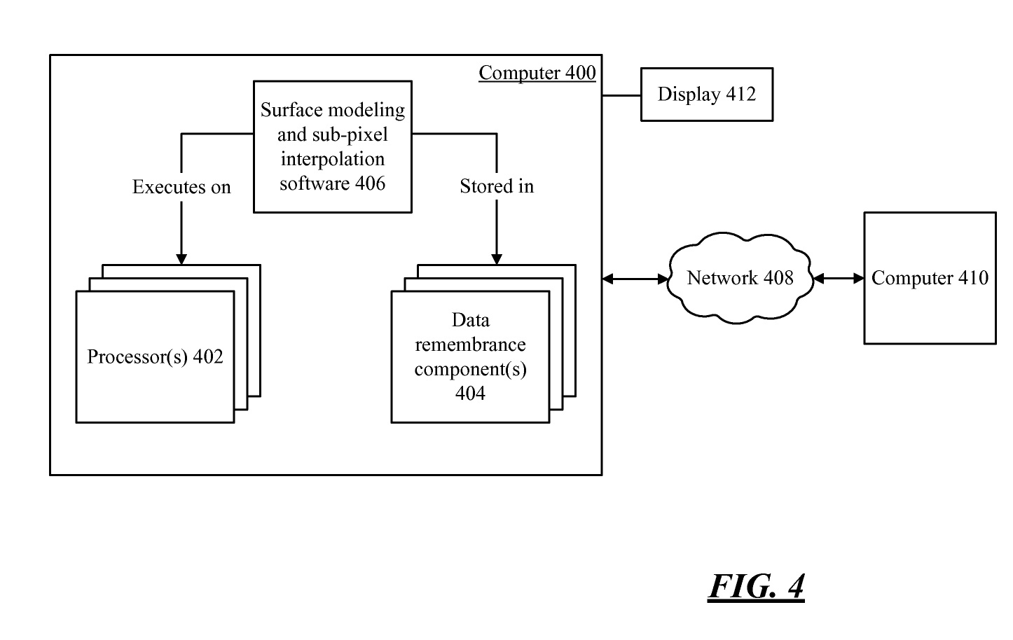

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is surface modeling and sub-pixel interpolation software 406, which may implement some or all of the functionality described above in connection with FIGS. 1-4, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

It is noted that the surface model built in accordance with the techniques described herein may be used for various purposes. In one example, the surface model may be used to render 3-D images of a terrain—e.g., on a computer display. In another example, the surface model may be used to produce a physical product, such as a map or globe with raised relief corresponding to the terrain.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium comprising executable instructions for creating a surface model, the executable instructions, when executed by a computer, causing the computer to perform acts comprising:
rectifying a first photograph and a second photograph to make a first axis of said first photograph coincide with said first axis of said second photograph and a second axis of said first photograph be parallel to said second axis of said second photograph, said first photograph and said second photograph having an overlapping region;
using a first set of analytic functions to interpolate sub-pixel values between pixels in said first photograph;
using a second set of analytic functions to interpolate sub-pixel values between pixels in said second photograph;
finding a first offset between said first photograph and said second photograph along said first axis that maximizes a similarity function calculated over interpolated sub-pixel values in said region; and
using said first offset to calculate a height of a point in said region, said height being part of said model.

2. The computer-readable medium of claim 1, said acts further comprising:
calculating said first offset by first calculating a second offset by maximizing said similarity function over discrete pixel values of said first photograph and said second photograph in said region, and then finding an third offset from said second offset that maximizes said similarity function over said interpolated sub-pixel values.

3. The computer-readable medium of claim 1, said analytic functions being linear functions.

4. The computer-readable medium of claim 1, said similarity function comprising normalized cross correlation.

5. The computer-readable medium of claim 1, said height of said point being calculated by triangulation.

6. The computer-readable medium of claim 1, said similarity function calculating similarity between pixels based on a 3×3 region around each pixel.

7. The computer-readable medium of claim 1, maximizing of said similarity function being performed by finding a root of a derivative of said similarity function.

8. A method creating a surface model, the method comprising:
using a processor to perform acts comprising:
rectifying a first aerial photograph and a second aerial photograph to make a first axis of said first aerial photograph coincide with said first axis of said second aerial photograph and a second axis of said first aerial photograph be parallel to said second axis of said second aerial photograph, said first aerial photograph and said second aerial photograph having an overlapping region;
using a first set of analytic functions to interpolate sub-pixel values between pixels in said first aerial photograph;
using a second set of analytic functions to interpolate sub-pixel values between pixels in said second aerial photograph;
finding a first offset between said first aerial photograph and said second aerial photograph along said first axis that maximizes a similarity function calculated over interpolated sub-pixel values in said region; and
using said first offset to calculate a height of a point in said region, said height being part of said model.

9. The method of claim 8, said acts further comprising:
calculating said first offset by first calculating a second offset by maximizing said similarity function over discrete pixel values of said first aerial photograph and said second aerial photograph in said region, and then finding an third offset from said second offset that maximizes said similarity function over said interpolated sub-pixel values.

10. The method of claim 8, said analytic functions being linear functions.

11. The method of claim 8, said similarity function comprising normalized cross correlation.

12. The method of claim 8, said height of said point being calculated by triangulation.

13. The method of claim 8, said similarity function calculating similarity between pixels based on a 3×3 region around each pixel.

14. The method of claim 8, maximizing of said similarity function being performed by finding a root of a derivative of said similarity function.

15. A system for creating a surface model, the system comprising:
a memory;
a processor; and
a component that is stored in said memory and that executes on said processor, that rectifies a first photograph and a second photograph to make a first axis of said first photograph coincide with said first axis of said second photograph and a second axis of said first photograph be parallel to said second axis of said second photograph, said first photograph and said second photograph having an overlapping region, said component using a first set of analytic functions to interpolate sub-pixel values between pixels in said first photograph, said component using a second set of analytic functions to interpolate sub-pixel values between pixels in said second photograph, said component finding a first offset between said first photograph and said second photograph along said first axis that maximizes a similarity function calculated over interpolated sub-pixel values in said region, and said component using said first offset to calculate a height of a point in said region, said height being part of said model.

16. The system of claim 15, said component calculating said first offset by first calculating a second offset by maximizing said similarity function over discrete pixel values of said first photograph and said second photograph in said region, and then finding an third offset from said second offset that maximizes said similarity function over said interpolated sub-pixel values.

17. The system of claim 15, said analytic functions being linear functions.

18. The system of claim 15, said similarity function comprising normalized cross correlation.

19. The system of claim 15, said height of said point being calculated by triangulation.

20. The system of claim 15, maximizing of said similarity function being performed by finding a root of a derivative of said similarity function.
